(19) United States
(12) Patent Application Publication
(10) Pub. No.: US 2014/0349808 A1
(43) Pub. Date: Nov. 27, 2014

(54) HYBRID TRANSPORTATION APPARATUS HAVING FUEL CELL AND AIR ENGINE

(71) Applicant: NATIONAL TSING HUA UNIVERSITY, Hsinchu City (TW)

(72) Inventors: Chih-Yung HUANG, Hsinchu City (TW); Cheng-Kuo SUNG, Hsinchu (TW); Chin-Min LIU, Douliu City (TW); Chao-An LIN, Hsinchu (TW)

(73) Assignee: NATIONAL TSING HUA UNIVERSITY, Hsinchu City (TW)

(21) Appl. No.: 13/962,488

(22) Filed: Aug. 8, 2013

(30) Foreign Application Priority Data
May 21, 2013 (TW) 102117825

(51) Int. Cl. B60W 20/00

(52) U.S. Cl. CPC B60W 20/40
USPC 477/3

(57) ABSTRACT

In a hybrid transportation apparatus, a gas supply provides high-pressure hydrogen, which drives a turbine to generate first mechanical power and becomes medium-pressure hydrogen, which drives an air engine to generate second mechanical power and becomes low-pressure hydrogen. A fuel cell generates first electric power according to the low-pressure hydrogen. A heat recycling module recycles heat, which is generated by the fuel cell, to warm up the high-pressure hydrogen or the medium-pressure hydrogen. A generator receives the first mechanical power and generates second electric power. A motor generates third mechanical power according to the first and second electric power. A power output device causes movement of the transportation apparatus according to the second and third mechanical power. Thus, potential energy and chemical energy of the high-pressure hydrogen can be effectively utilized to generate the mechanical power and the electric power to move the transportation apparatus.

This application claims priority of No. 102117825 filed in Taiwan R.O.C. on May 21, 2013 under 35 USC 119, the entire content of which is hereby incorporated by reference.

### BACKGROUND OF THE INVENTION

1. Field of the Invention

The invention relates to a hybrid transportation apparatus, and more particularly to a hybrid transportation apparatus with a fuel cell and an air engine.

2. Related Art

Due to the energy shortage and the environmental change, a lot of new technology in the vehicle design has been developed recently. More particularly, the vehicle using the alternative energy (e.g., the dual electric vehicle using the fuel cell and the lithium battery, the vehicle using the natural gas, or the hybrid vehicle) has sprung up like mushrooms.

The efficiency of the motor of the hydrogen fuel cell powered vehicle is two to three times higher than that of the internal combustion engine so that the advantages of zero emission, low noise and zero vibration are obtained. The hydrogen can be easily extracted from the natural gas, sea coal and crude. The fuel cell generates the electric power through the chemical reaction of the combination of hydrogen and oxygen, and the heat is the only one byproduct.

The air engine (or referred to as a pneumatic motor) converts the pressure energy of the compressed gas into the mechanical energy and functions as a motor or a hydraulic motor. The high-pressure gas drives the air engine so that no contamination is generated. The air engine may be installed on a bicycle, a motorcycle, a vehicle, a boat or a ship to serve as the main power source for replacing the currently used motor and internal combustion engine. Alternatively, the air engine may also serve as an auxiliary power source for the motorcycle, vehicle, boat or ship in order to reduce the contamination generated by the internal combustion engine.

Because the vehicle installed with the fuel cell and the air engine generates no contamination, it is a great help to the current industry development if the fuel cell and the air engine can be effectively integrated with the enhanced integrated efficiency.

### SUMMARY OF THE INVENTION

An object of the invention is to provide a hybrid transportation apparatus having a fuel cell and an air engine, wherein the pressure energy and the chemical energy of the high-pressure hydrogen can be effectively extracted by the air engine for generating the mechanical power and the fuel cell for generating the electric power to cause the movement of the transportation apparatus.

The invention achieves the above-identified object by providing a hybrid transportation apparatus including a gas supply, a turbine, an air engine, a fuel cell, a heat recycling module, a generator, a motor and a power output device. The gas supply provides high-pressure hydrogen. The turbine communicates with the gas supply through a high-pressure conduit. The high-pressure hydrogen drives the turbine to generate first mechanical power and becomes medium-pressure hydrogen. The air engine communicates with the turbine through a medium-pressure conduit and receives the medium-pressure hydrogen. The medium-pressure hydrogen drives the air engine to generate second mechanical power and becomes low-pressure hydrogen. The fuel cell communicates with the air engine through a low-pressure conduit, receives the low-pressure hydrogen, and generates first electric power according to the low-pressure hydrogen. The heat recycling module recycles heat, generated by the fuel cell, and warms up the high-pressure hydrogen in the high-pressure conduit or the medium-pressure hydrogen in the medium-pressure conduit. The generator receives the first mechanical power and generates second electric power. The motor is electrically connected to the generator and the fuel cell and generates third mechanical power according to the first electric power and the second electric power. The power output device causes movement of the transportation apparatus according to the second mechanical power and the third mechanical power.

With the hybrid transportation apparatus of the invention, the high-pressure hydrogen drives the turbine, which decompresses the high-pressure hydrogen to generate the electric energy. Then, the medium-pressure hydrogen is supplied to the air engine, which generates the mechanical energy. Next, the low-pressure hydrogen outputted from the air engine is supplied to the fuel cell, which generates the electric energy and the heat. The heat is provided to warm up the high-pressure hydrogen or the medium-pressure hydrogen to increase its energy, so that the air engine can output the higher mechanical energy. The mechanical energy and the electric energy are utilized to cause the movement of the transportation apparatus, so that the decompression loss can be decreased, the reuse of the heat can be increased, and the environment contamination can be decreased.

Further scope of the applicability of the present invention will become apparent from the detailed description given hereinafter. However, it should be understood that the detailed description and specific examples, while indicating preferred embodiments of the present invention, are given by way of illustration only, since various changes and modifications within the spirit and scope of the present invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention.

FIG. 1 is a schematic block diagram showing a hybrid transportation apparatus according to a first embodiment of the invention.

FIG. 2 is a schematic block diagram showing a hybrid transportation apparatus according to a second embodiment of the invention.

FIGS. 3 and 4 are schematic block diagrams showing two examples of heat recycling modules according to the invention.

### DETAILED DESCRIPTION OF THE INVENTION

The present invention will be apparent from the following detailed description, which proceeds with reference to the accompanying drawings, wherein the same references relate to the same elements.

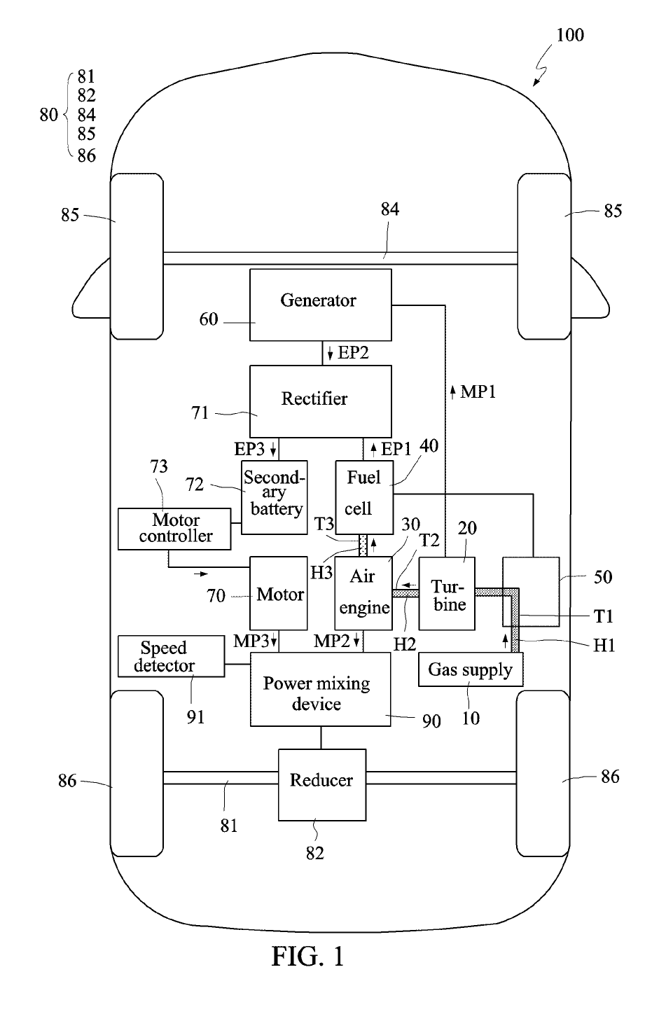

FIG. 1 is a schematic block diagram showing a hybrid transportation apparatus 100 according to a first embodiment of the invention. Referring to FIG. 1, the hybrid transportation apparatus 100 includes a gas supply 10, a turbine 20, an air engine 30, a fuel cell 40, a heat recycling module 50, a generator 60, a motor 70 and a power output device 80. Although a four-wheeler vehicle serves as an example of the transportation apparatus, it is to be understood that the hybrid transportation apparatus 100 includes, without limitation to, boats and ships, aircrafts, three-wheelers, two-wheelers and the like. When the hybrid transportation apparatus 100 is the vehicle, the overall power output can cause the movement relative to the road or the ground through the rotating wheel(s). When the hybrid transportation apparatus 100 is the boat, ship or aircraft, the overall power output can cause the movement relative to the carrier (water or air) through the rotating propeller(s).

The gas supply 10 may be implemented by a high-pressure cylinder for providing the hydrogen for the air engine 30 and the fuel cell 40. The hydrogen of the gas supply 10 is present in the form of ultra-high-pressure hydrogen in order to increase the energy that can be stored per unit volume. The gas supply 10 itself has a throttle (not shown). Controlling the opening of the throttle can control the gas flow of the gas supply 10 to provide the high-pressure hydrogen H1. In an exemplified but non-restrictive example, the high-pressure hydrogen in the high-pressure cylinder has the pressure ranging from about 150 to 700 bars, and is decompressed into the medium-pressure hydrogen, having the pressure ranging from about 15 to 20 bars, through the turbine 20, and the medium-pressure hydrogen is outputted to the air engine 30. The air engine 30 outputs the low-pressure hydrogen, having the pressure ranging from about 1 to 4 bars, to the fuel cell 40. It is to be noted that the range of the pressure may be adjusted according to the requirement and does not intend to restrict the invention thereto.

The turbine 20 communicates with the gas supply 10 through a high-pressure conduit T1. The turbine 20 converts the potential energy of the high-pressure hydrogen H1 into the available mechanical energy to drive the generator 60 to generate the electric power, and thus has the advantages of the high rotating speed and the high power generating efficiency. Meanwhile, the turbine 20 also decompresses the high-pressure hydrogen H1. Thus, the high-pressure hydrogen H1 drives the turbine 20 to generate first mechanical power MP1 and then becomes medium-pressure hydrogen H2. The pressure of the medium-pressure hydrogen H2 is higher than the pressure of the high-pressure hydrogen H1.

The air engine 30 communicates with the turbine 20 through a medium-pressure conduit T2 and receives the medium-pressure hydrogen H2. The medium-pressure hydrogen H2 drives the air engine 30 to generate second mechanical power MP2 and then becomes low-pressure hydrogen H3. The pressure of the low-pressure hydrogen H3 is lower than the pressure of the medium-pressure hydrogen H2.

The fuel cell 40 is a device for directly converting the chemical energy of the fuel gas (hydrogen) into the electric energy. The main structure of the fuel cell 40 includes electrodes and an electrolyte. Such process of directly converting the chemical energy into the electric energy has the efficiency higher than more than 30% of that of the internal combustion engine system. If the generated recycled waste heat is further considered, the total energy availability reaching as high as 85% may be obtained. So, the fuel cell is the energy system with the high economic effectiveness. The fuel cell 40 communicates with the air engine 30 through a low-pressure conduit T3, and receives the low-pressure hydrogen H3. The fuel cell 40 generates first electric power EP1 according to the low-pressure hydrogen H3. In this embodiment, the hydrogen fuel cell 40 is adopted to generate the first electric power EP1.

The turbine 20 can achieve the effects of decompressing the high-pressure hydrogen H1 and generating the mechanical power according to the high-pressure hydrogen H1. The high-pressure cylinder is used to store more compressed hydrogen so as to increase the endurance. However, the operation of the air engine 30 does not need the too-high pressure. In other words, the high-pressure hydrogen, after being decompressed by the air engine 30, has the pressure still higher than the applicable pressure of the fuel cell 40. Thus, the utilization of the turbine 20 can solve this problem, avoid the waste of the hydrogen and additionally generate the first mechanical power MP1.

The heat recycling module 50 recycles the heat, generated by the fuel cell 40, and warms up the high-pressure hydrogen H1 in the high-pressure conduit T1. Of course, in another example, the recycled heat may warm up the medium-pressure hydrogen H2 in the medium-pressure conduit T2. The heat recycling module 50 has the high heat transfer rate, has no movable member and needs not to be maintained. The heat recycling module 50 also recycles the heat, generated by the fuel cell 40, and rapidly transfers the heat to the outlet end of the high-pressure cylinder almost without heat transfer loss. The high-pressure hydrogen H1 is again introduced into the turbine 20 and the air engine 30 to increase the efficiency of the turbine 20 and the air engine 30, so that the turbine 20 and the air engine 30 can output the higher horse power and the higher torque, and the effects of saving the energy and increasing the overall efficiency of the hydrogen fuel cell can be obtained.

The generator 60 receives the first mechanical power MP1 and generates second electric power EP2. The generator 60 may be a DC generator or an AC generator for converting the mechanical power into the electric power to drive the motor 70.

Both the fuel cell 40 and the generator 60 can generate the electric power to drive the motor 70. In this embodiment, the motor 70 is electrically connected to the generator 60 and the fuel cell 40 through a rectifier 71, a secondary battery 72 and a motor controller 73, and generates third mechanical power MP3 according to the first electric power EP1 and the second electric power EP2. The rectifier 71 can perform suitable processing, such as rectifying, regulating and/or mixing, on the first electric power EP1 and the second electric power EP2, and then generate third electric power EP3 charged into the secondary battery 72. The available secondary battery 72 comprises a lead-acid battery, a lithium-ion battery, a lithium polymer battery, a lithium iron battery or the like, which mainly provides functions of storing the electric power and stabilizing the discharge. The motor controller 73 controls the operation state and speed of the motor 70 according to the electric power from the secondary battery 72 and the state of the accelerator pedal of the transportation apparatus 100 to facilitate the manipulation of the driver. It is to be noted that although the intermediate electronic assemblies for electrically connecting the motor 70 to the generator 60 and the fuel cell 40 include the rectifier 71, the secondary battery 72 and the motor controller 73 in this embodiment, the intermediate electronic assemblies can be adjusted and modified according to the design requirements in other embodiments. So, the invention is not austerely restricted thereto.

The power output device 80 causes movement of the transportation apparatus 100 according to the second mechanical power MP2 and the third mechanical power MP3. In this embodiment, the power output device 80 is mechanically connected to the air engine 30 and the motor 70 through a power mixing device 90. The power mixing device 90 mixes the second mechanical power MP2 and the third mechanical power MP3 with each other. In addition to a power transmission mechanism, the power mixing device 90 may also include the electrical control function for mainly controlling the operation mode (to be described later). In addition to the connection to a speed detector 91, the power mixing device 90 may also be electrically connected to each essential element of the transportation apparatus 100 (will not be particularly depicted herein). The power mixing device 90 can transfer the mechanical energy of the air engine to drive the reducer, or drive the reducer through the motor so that the power mixing device 90 operates in the state with the optimum power performance. The power mixing device 90 connects the crankshaft of the air engine and the rotating shaft of the motor to a reducer 82 through transmission elements, such as gears, belts or the like.

In this embodiment, the power output device 80 includes an axle 81 and the reducer 82. The reducer 82 connected to the axle 81 receives the second mechanical power MP2 and the third mechanical power MP3 to drive the axle 81 to rotate. Rear wheels 86, which rotate relatively to the ground to cause the movement of the hybrid transportation apparatus 100, are mounted on the axle 81. It is to be noted that the mechanism may be designed such that the second mechanical power MP2 and the third mechanical power MP3 drive the front wheels 85 to rotate through the axle 84. The power mixing device 90 may be implemented by way of, for example, coupling the second mechanical power MP2 and the third mechanical power MP3 to the reducer through the transmission gear(s) or belt(s) to drive the axle to rotate.

The mode mentioned hereinabove is a hybrid mode, wherein the power mixing device 90 controls one or multiple ones of the gas supply 10, the turbine 20, the air engine 30, the fuel cell 40, the generator 60 and the motor 70 to make the power output device 80 cause the movement of the transportation apparatus 100 according to the second mechanical power MP2 and the third mechanical power MP3. This mode is suitable for the condition when the driver stomps on the accelerator pedal, or the condition when the moving speed of the vehicle measured by the speed detector 91 approaches the highest speed of the medium speed range, which represents that the driver hopes to obtain the larger torque output. In this case, the air engine continues operating to provide the power, and the power mixing device 90 enables the motor controller 73 to drive the motor 70. The output power of the motor 70 and the power of the air engine are summated to obtain the total output so as to provide the maximum power output for the vehicle.

It is to be noted that the transportation apparatus 100 may also have an electric power mode and a pneumatic mode. The power mixing device 90 controls one or multiple ones of the gas supply 10, the turbine 20, the air engine 30, the fuel cell 40, the generator 60 and the motor 70 to make the power output device 80 cause the movement of the transportation apparatus 100 according to only the third mechanical power MP3 in the electric power mode; and to make the power output device 80 cause the movement of the transportation apparatus 100 according to only the second mechanical power MP2 in the pneumatic mode.

Thus, in the electric power mode, the speed detection can obtain whether the vehicle is in the stationary or low battery state, so that the power mixing device 90 can control the motor controller 73 to make the motor 70 provide the starting power or the power for the low speed or even the medium speed. This is suitable for the urban road, or the state when the secondary battery 72 is in the highly charged state. Thus, the power mixing device 90 may select to enter the hybrid mode or the electric power mode according to the speed of the transportation apparatus 100. In the pneumatic mode, when the motor 70 or the motor controller 73 fails, or the secondary battery 72 fails (including the low battery state), it is possible to switch to the air engine 30 for outputting the mechanical power so that the vehicle can go back to the repair plant and can be repaired. That is, the power mixing device 90 enters the pneumatic mode upon detection of the failure of the secondary battery 72 or the motor 70.

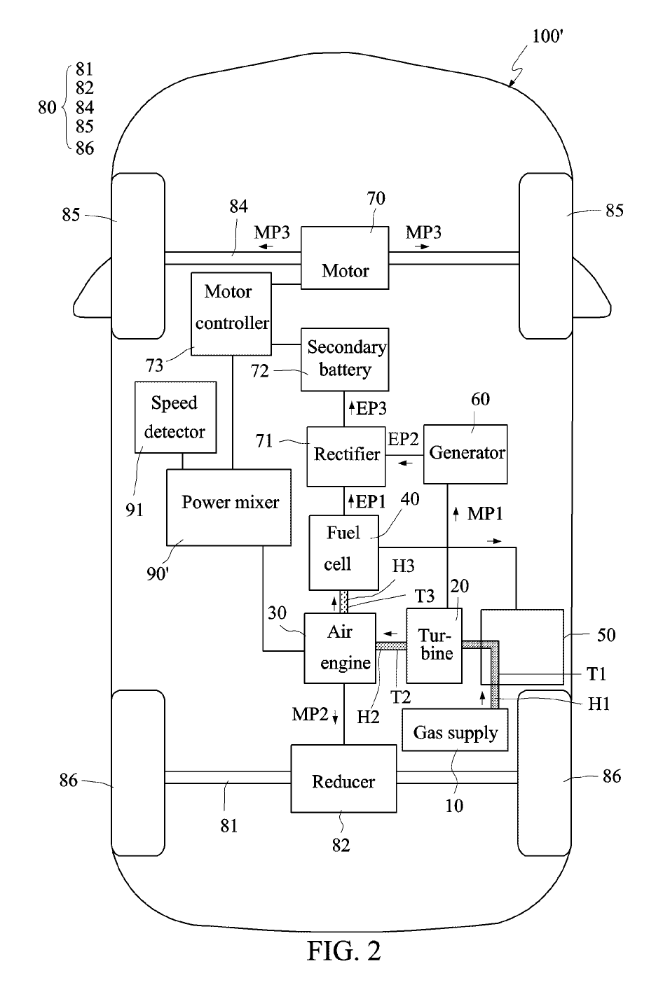

FIG. 2 is a schematic block diagram showing a hybrid transportation apparatus 100′ according to a second embodiment of the invention. As shown in FIG. 2, this embodiment is similar to the first embodiment except that the motor 70 and the air engine 30 drive the front wheels 85 and the rear wheels 86 of the transportation apparatus 100′ to rotate through the axle 84 and the axle 81, respectively. Thus, the power mixer 90′ is electrically connected to the motor controller 73 and the air engine 30 and respectively controls the motor 70 and the air engine 30 to rotate. Therefore, in this embodiment, the second mechanical power MP2 and the third mechanical power MP3 drive the rear wheel 86 and the front wheel 85 of the power output device 80 or drive the front wheel 85 and the rear wheel 86, respectively, to cause the movement of the transportation apparatus 100.

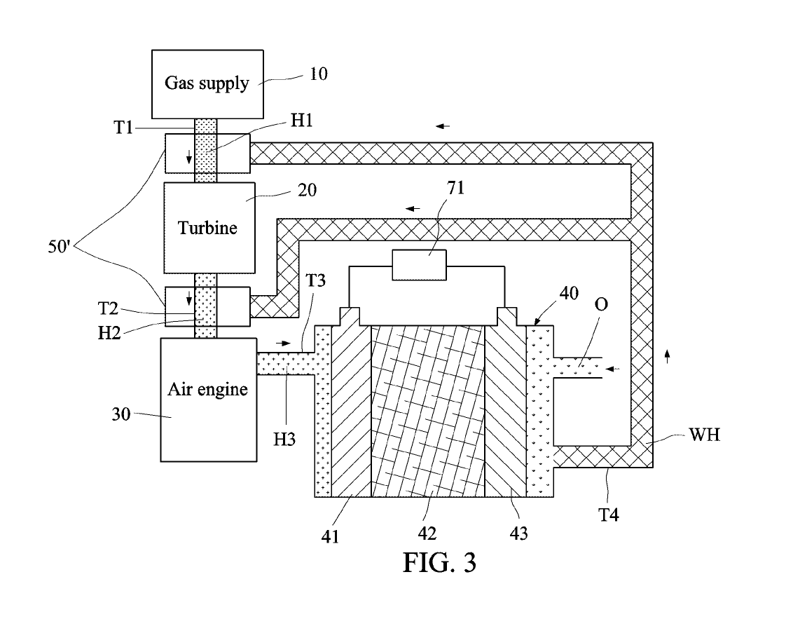

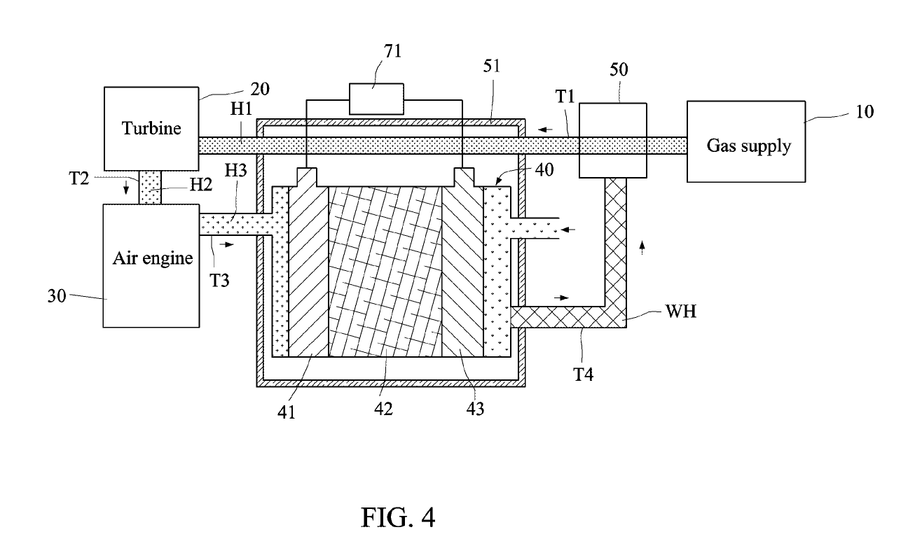

FIGS. 3 and 4 are schematic block diagrams showing two examples of heat recycling modules according to the invention. Referring to FIG. 3, the heat recycling module 50′ recycles the heat, generated by the fuel cell 40, through a conduit T4 and warms up the high-pressure hydrogen H1 and the medium-pressure hydrogen H2 in the high-pressure conduit T1 and the medium-pressure conduit T2, respectively. The low-pressure hydrogen H3 enters an anode 41 of the fuel cell 40, and oxygen O enters a cathode 43 of the fuel cell 40, so that the electric power is generated through an electrolyte 42 of the fuel cell 40 and supplied to the rectifier 71.

Referring to FIG. 4, the heat recycling module 50 includes a cover body 51 covering the fuel cell 40 and the high-pressure conduit T1. Of course, the waste heat WH, generated by the fuel cell 40, may also be transferred to the heat recycling module 50 through the conduit T4. Alternatively, in another example, the heat recycling module 50 is achieved by penetrating the high-pressure conduit T1 through the fuel cell units of the fuel cell 40 that are connected in series or in parallel. Thus, even if the mechanism for circulating the waste heat WH fails, the waste heat WH, generated by the fuel cell 40, still can be extracted immediately through the high-pressure conduit T1 passing through the fuel cell 40.

With the embodiments of the invention, the high-pressure hydrogen drives the turbine, which decompresses the high-pressure hydrogen to generate the electric energy. Then, the medium-pressure hydrogen is supplied to the air engine, which generates the mechanical energy. Next, the low-pressure hydrogen outputted from the air engine is supplied to the fuel cell, which generates the electric energy and the heat. The heat is provided to warm up the high-pressure hydrogen or the medium-pressure hydrogen to increase its energy, so that the air engine can output the higher mechanical energy. The mechanical energy and the electric energy are utilized to cause the movement of the transportation apparatus, so that the decompression loss can be decreased, the reuse of the heat can be increased, and the environment contamination can be decreased.

While the present invention has been described by way of examples and in terms of preferred embodiments, it is to be understood that the present invention is not limited thereto. To the contrary, it is intended to cover various modifications. Therefore, the scope of the appended claims should be accorded the broadest interpretation so as to encompass all such modifications.

What is claimed is:

1. A hybrid transportation apparatus, comprising:
a gas supply providing high-pressure hydrogen;
a turbine communicating with the gas supply through a high-pressure conduit, wherein the high-pressure hydrogen drives the turbine to generate first mechanical power and becomes medium-pressure hydrogen;
an air engine, which communicates with the turbine through a medium-pressure conduit and receives the medium-pressure hydrogen, wherein the medium-pressure hydrogen drives the air engine to generate second mechanical power and becomes low-pressure hydrogen;
a fuel cell, which communicates with the air engine through a low-pressure conduit, receives the low-pressure hydrogen, and generates first electric power according to the low-pressure hydrogen;
a heat recycling module, which recycles heat, generated by the fuel cell, and warms up the high-pressure hydrogen in the high-pressure conduit or the medium-pressure hydrogen in the medium-pressure conduit;
a generator, which receives the first mechanical power and generates second electric power;
a motor, which is electrically connected to the generator and the fuel cell and generates third mechanical power according to the first electric power and the second electric power; and
a power output device causing movement of the transportation apparatus according to the second mechanical power and the third mechanical power.

2. The hybrid transportation apparatus according to claim 1, wherein the heat recycling module comprises:
a cover body covering the fuel cell and the high-pressure conduit.

3. The hybrid transportation apparatus according to claim 1, wherein the heat recycling module is achieved by penetrating the high-pressure conduit through the fuel cell.

4. The hybrid transportation apparatus according to claim 1, wherein the motor is electrically connected to the generator and the fuel cell through a rectifier, a secondary battery and a motor controller.

5. The hybrid transportation apparatus according to claim 4, wherein the power output device is mechanically connected to the air engine and the motor through a power mixing device, and the power mixing device mixes the second mechanical power and the third mechanical power with each other.

6. The hybrid transportation apparatus according to claim 5, wherein the power mixing device controls one or multiple ones of the gas supply, the turbine, the air engine, the fuel cell, the generator and the motor, so that:
the power output device causes the movement of the transportation apparatus according to the second mechanical power and the third mechanical power in a hybrid mode;
the power output device causes the movement of the transportation apparatus according to only the third mechanical power in an electric power mode; and
the power output device causes the movement of the transportation apparatus according to only the second mechanical power in a pneumatic mode.

7. The hybrid transportation apparatus according to claim 6, wherein the power mixing device selects to enter the hybrid mode or the electric power mode according to a speed of the transportation apparatus.

8. The hybrid transportation apparatus according to claim 6, wherein the power mixing device enters the pneumatic mode upon detection of failure of the secondary battery or the motor.

9. The hybrid transportation apparatus according to claim 1, wherein the second mechanical power and the third mechanical power drive a front wheel and a rear wheel or a rear wheel and a front wheel of the power output device, respectively, to cause the movement of the transportation apparatus.

10. The hybrid transportation apparatus according to claim 1, wherein the power output device comprises:
an axle; and
a reducer, which is connected to the axle and receives the second mechanical power and the third mechanical power to drive the axle to rotate.
